(19) United States
(12) Patent Application Publication
(10) Pub. No.: US 2006/0044966 A1
(43) Pub. Date: Mar. 2, 2006

(54) Method of determining the type of an optical disc and a data recording and/or reproducing apparatus

(75) Inventors: Kwang-ok An, Suwon-si (KR); Byung-in Ma, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/074,932

(22) Filed: Mar. 9, 2005

(30) Foreign Application Priority Data
Aug. 13, 2004 (KR) 2004-63758

(51) Int. Cl. G11B 5/09

(52) U.S. Cl. 369/47.1; 369/47.32

(57) ABSTRACT

A method of determining an optical disc type and a data recording and/or reproducing apparatus. The method of determining the type of an optical disc loaded in a data recording and/or reproducing apparatus includes reading optical disc type determination order stored in a memory included in the data recording and/or reproducing apparatus in order to determine a type of the optical disc from a plurality of optical disc types, and controlling a read/write unit in the data recording and/or reproducing apparatus according to the determination order to determine the type of the optical disc. According to the present invention, an optical disc using pattern of users, optical disc using frequency according to type, and a point of time in which an optical disc is used are considered to change an order for optical disc type determination to allow to rapidly determine the type of a loaded optical disc.

### CROSS-REFERENCE TO RELATED APPLICATION

This application claims the benefit of Korean Patent Application No. 2004-63758, filed Aug. 13, 2004 in the Korean Intellectual Property Office, the disclosure of which is incorporated herein by reference.

### BACKGROUND OF THE INVENTION

1. Field of the Invention

The present invention relates to a method of determining the type of an optical disc and a data recording and/or reproducing apparatus.

2. Description of the Related Art

There are various types of information storage media on which information is stored. Such media include magnetic discs, such as floppy discs and hard discs, semiconductor memory chips such as ROMs or RAMs, and optical discs on which data is recorded using a laser.

Optical discs are very widely used because optical discs have large information storage capacity and costs thereof are comparatively low. Optical discs are classified into compact discs (CDs), digital versatile discs (DVDs), and BLU-RAY discs (BD), which are next generation discs, according to the information storage capacity therein.

Generally, data may be read from or written onto various types of optical discs using a data recording and/or reproducing apparatus. When an optical disc is loaded into a data recording and/or reproducing apparatus, the data recording and/or reproducing apparatus determines the type of the loaded optical disc. The type of the loaded optical disc may be certainly known by reproducing data recorded in a lead-in area of the optical disc, but a problem exists in that the data recording and/or reproducing apparatus may reproduce data before the type of the loaded optical disc is known. Accordingly, in the conventional art, the type of an optical disc may be determined according to a previously determined optical disc determination order. For example, if an optical disc determination order previously determined by a manufacturer of a data recording and/or reproducing apparatus is BD, DVD, and CD, the data recording and/or reproducing apparatus determines whether a loaded optical disc is a BD. In order to determine whether the loaded disc is a BD, the data recording and/or reproducing apparatus sets each parameter corresponding to a BD such as a power value of a laser diode. After that, a laser is scanned on the optical disc, and whether the loaded optical disc is a BD is determined based on a signal obtained by moving an objective lens up/down.

When the loaded optical disc is not a BD, whether the loaded optical disc is a DVD is determined. In order to determine whether the loaded disc is a DVD, a process similar to the process described above is performed. As such, the data recording and/or reproducing apparatus sets each parameter corresponding to a DVD such as a power value of a laser diode, scans a laser on the optical disc, and determines whether the loaded optical disc is a DVD based on a signal obtained by moving the objective lens up/down. When the loaded optical disc is not a DVD, whether the loaded optical disc is a CD is determined. When the loaded optical disc is not a CD, whether the loaded disc is an unknown disc is finally determined.

As is described above, in the conventional art, when an optical disc is loaded on the data recording and/or reproducing apparatus, an optical disc type determination process takes place according to a previously determined order. Accordingly, when the determination order is BD, DVD, and CD, an initialization time of the data recording and/or reproducing apparatus in which a CD is loaded is always longer than an initialization time of the data recording and/or reproducing apparatus in which a BD or a DVD is loaded. During the Initialization time, the data recording and/or reproducing apparatus is turned on and information about a loaded optical disc is obtained.

### SUMMARY OF THE INVENTION

An aspect of the present invention provides a data recording and/or reproducing apparatus which relatively rapidly determines a type of a loaded optical disc to reduce an initialization time to use the optical disc.

The present invention also provides an optical disc type determination method in which a type of a loaded optical disc is rapidly determined to reduce an initialization time to use the optical disc.

According to an aspect of the present invention, a data recording and/or reproducing apparatus which reads/writes data from/onto optical discs of different types, includes a read/write unit which reads/writes data from/to a loaded optical disc, a memory which stores an optical disc type determination order to determine a type of the optical disc from a plurality of optical disc types, and a control unit which controls the read/write unit according to the optical disc type determination order stored in the memory to determine the type of the optical disc.

According to another aspect of the present invention, a data recording and/or reproducing apparatus which reads/writes data from/onto optical discs of different types, includes a read/write unit which reads/writes data from/to a loaded optical disc, a memory which stores frequencies of optical disc types and an optical disc type determination order based on the frequencies, and a control unit which controls the read/write unit to determine the type of the loaded optical disc according to the determination order stored in the memory.

According to still another aspect of the present invention, a data recording and/or reproducing apparatus which reads/writes data from/onto optical discs of different types, includes a read/write unit which reads/writes data from/onto a loaded optical disc, a memory which stores information on an optical discs use record in which an optical disc recently loaded on the data recording and/or reproducing apparatus is highly weighted and an optical disc type determination order based on the information on the optical disc use record, and a control unit which controls the read/write unit according to the determination order stored in the memory to determine the type of the loaded optical disc.

According to yet another aspect of the present invention, a method of determining the type of an optical disc loaded in a data recording and/or reproducing apparatus, includes reading an optical disc type determination order stored in a memory included in the data recording and/or reproducing apparatus in order to determine a type of the optical disc from a plurality of optical disc types, and controlling a read/write unit in the data recording and/or reproducing apparatus according to the determination to determine the type of the optical disc.

According to a further aspect of the present invention, a method of determining the type of an optical disc loaded in a data recording and/or reproducing apparatus, includes reading an optical disc type determination order based on frequencies of optical disc types, the determination order being stored in a memory included in the data recording and/or reproducing apparatus, and controlling a read/write unit in the data recording and/or reproducing apparatus according to the determination to determine the type of the loaded optical disc.

According to another aspect of the present invention, a method of discriminating the type of an optical disc loaded in a data recording and/or reproducing apparatus, includes reading an optical disc type determination order stored in a memory included in the data recording and/or reproducing apparatus and having been determined based on the information on an optical disc use record in which an optical disc recently loaded on the data recording and/or reproducing apparatus is highly weighted, and controlling a read/write unit of the data recording and/or reproducing apparatus according to the determination to determine the type of a loaded optical disc.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a data recording and/or reproducing apparatus according to an embodiment of the present invention;

FIG. 2 is a flow chart of an optical disc type determination method according to an embodiment of the present invention;

FIG. 3 is a flow chart illustrating an example of an optical disc type determination process according to an embodiment of the present invention;

FIG. 4A is a diagram of a memory storing priority information for initial optical disc type determination according to an embodiment of the present invention;

FIG. 4B is a diagram of a memory storing priority information of an updated optical disc type determination order according to an embodiment of the present invention;

FIG. 4C is a diagram of a memory in which priority information of updated optical disc type determination order according to another embodiment of the present invention;

FIG. 5 is a flow chart of an optical disc type determination method according to another embodiment of the present invention;

FIG. 6 is a flow chart of an optical disc type determination method according to another embodiment of the present invention;

FIG. 7 is a diagram of an example of information about optical disc using specification according to the embodiment of the present invention shown in FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

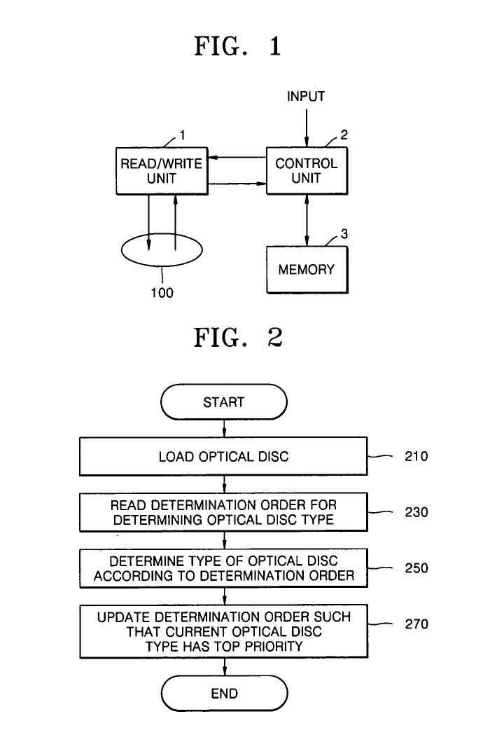

FIG. 1 is a block diagram of a data recording and/or reproducing apparatus according to an embodiment of the present invention. Referring to FIG. 1, the data recording and/or reproducing apparatus includes a read/write unit 1, a control unit 2, and a memory 3.

The read/write unit 1 writes data on an optical disc 100 that is loaded according to a control of the control unit 2. The read/write unit alternatively reads data recorded on the optical disc 100. The read/write unit 1 includes a spindle motor rotating the optical disc 100 and a pickup. The pickup includes a laser diode and a lens. It is understood, therefore, that the read/write 1 unit may write data onto the optical disc, read data from the optical disc, or both read and write onto and from the optical disc.

The control unit 2 controls entire operations of the data recording and/or reproducing apparatus. Namely, the read/write unit 1 is controlled such that data is recorded on the optical disc 100 or such that data that is recorded on the optical disc 100 is also read via a predetermined signal process. When the optical disc 100 is loaded, the control unit 2 determines the type of the optical disc 100 by referring to order information, including an optical disc type determination order that is stored in the memory 3. The control unit 2 updates the order information stored in the memory 3 after the type of the optical disc 100 is determined.

The control unit 2 includes an RF chip, which converts light that is reflected from the optical disc 100 into an RF signal, a Digital Signal Processor (DSP), which receives the RF signal and performs channel decoding and error correction, a servo, which performs focusing and tracking, an interface, and a system controller, not separately shown.

The memory 3 stores information about determination order of the optical disc type. When the type of the loaded optical disc 100 is determined by the control unit 2, the order is updated by the control unit 2. The information about the determination order is stored at a specific address of the memory 3. On the other hand, the memory 3 may be nonvolatile because the memory 3 is required to continuously store data even though power is not supplied to the data recording and/or reproducing apparatus.

Hereinafter, a method of determining an optical disc type according to an embodiment of the present invention, which is performed by the data recording and/or reproducing apparatus of FIG. 1, will now be described.

FIG. 2 is a flow chart of an optical disc type determination method according to an embodiment of the present invention.

When the optical disc 100 is loaded in the data recording and/or reproducing apparatus (operation 210), the control unit 2 reads information about a determination order optical stored in the memory 3 (operation 230). The information about the determination order is updated based on a type of an optical disc used previously in the data recording and/or reproducing apparatus.

The control unit 2 determines the type of the optical disc 100 loaded according to the determination order read from the memory 3 (operation 250).

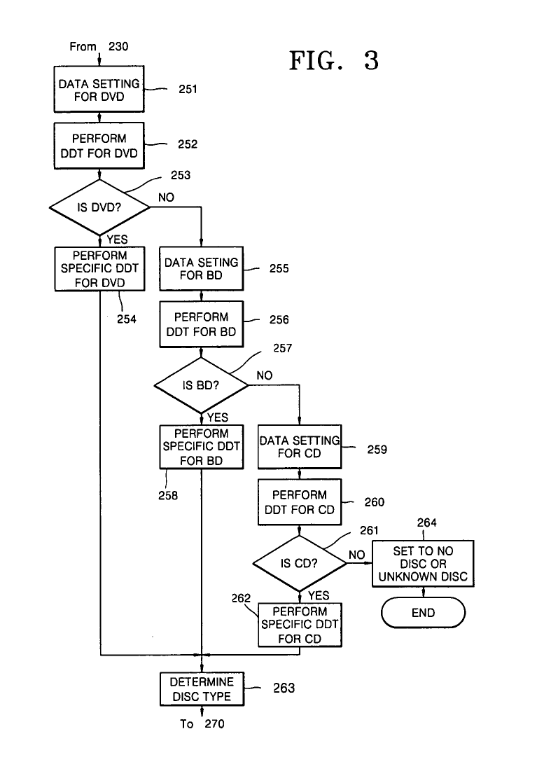

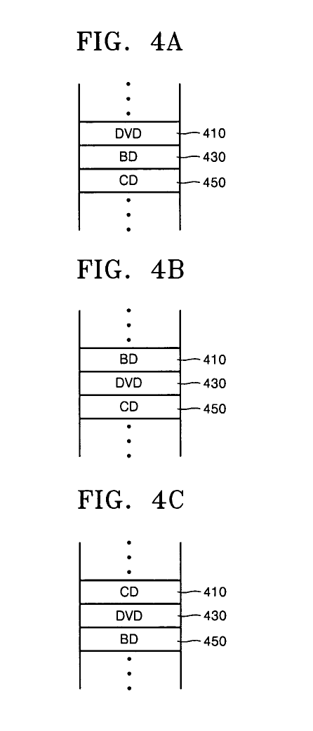

FIG. 3 is a flow chart illustrating an example of a process of optical disc type determination. When the determination order read from the memory 3 is DVD, BD, and CD as shown in FIG. 4A, the control unit 2 determines first whether the optical disc 100 is a DVD. Namely, various data (for example, power value of a laser diode corresponding to a DVD and phase alignment of the pickup to determine whether the optical disc 100 is a DVD) are set (operation 251). After the data are set, a disc detection (DDT) process is performed (operation 252). The DDT process is performed based on a signal, which is obtained by scanning a laser on the optical disc 100 and moving an objective lens up/down.

According to the result of the DDT, whether the loaded optical disc 100 is a DVD is determined (operation 253). When the loaded optical disc 100 is determined to be a DVD, a specific DDT process that is related to DVDs (operation 254) is performed. The specific DVD related DDT process determines what kind of a DVD the DVD is. Namely, in an embodiment of the invention, the DVD specific DDT process determines whether the DVD is a rewritable DVD or a read only DVD. In addition, the DVD specific DDT process corresponds to an operation in which an initial process to use the optical disc 100, in which information written in a read-in area of the optical disc 100 is read, is finished. It is understood that the DVD specific DDT process may determine other characteristics of the DVD.

If the loaded optical disc 100 is determined to not be a DVD, whether the loaded optical disc 100 is a BD is determined according to the determination order. Similar to operations 251 through 254, the control unit 2 sets various data, turns a laser diode on, and performs a BD DDT process (operations 255 and 256).

If the loaded optical disc 100 is determined to be a BD (operation 257), a BD related DDT process is performed (operation 258). If the loaded optical disc 100 is determined to not be a BD, finally, whether the loaded optical disc 100 is a CD is determined according to operations 259 through 264.

Referring to FIG. 2, when the type of the optical disc 100 is determined according to 250, the control unit 2 updates the determination order of optical disc type determination such that whatever the type of the optical disc 100 that is loaded into the apparatus is becomes the first element in the determination order (operations 270).

FIG. 4B shows the memory 3 in which updated determination order for optical disc type determination is stored when the type of the optical disc 100 is a BD. FIG. 4C shows the memory 3 in which an updated determination order, to be used for optical disc type determination, is stored when the optical disc 100 is a CD. A type of disc which is stored at a first position address 410 of the memory 3 has top priority. Discs are ranked in an order in which a second type of a disc is stored at a second position address 430 and a third type of a disc is stored at a third position address 450. Other orders of priority for the second highest priority type of disc and any lower priority type of disc may be determined by various methods. For example, if a disc corresponding to the top priority is a BD, the second element may be a DVD and third is a CD. Here, it is understood that the invention is not limited to the method described above and may involve various methods.

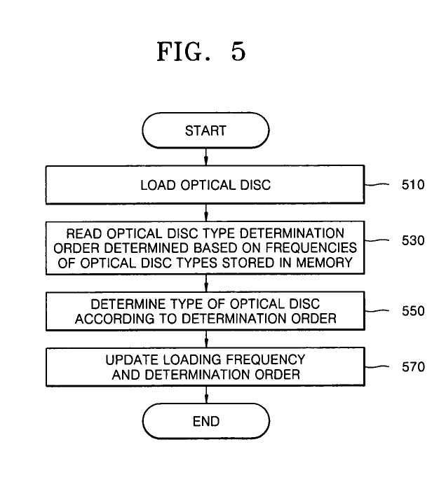

FIG. 5 is a flow chart of an optical disc type determination method according to another embodiment of the present invention. In the optical disc type determination method according to the embodiment of the present invention of FIG. 2, the determination order is updated such that a type of an optical disc which is recently used by a user becomes top priority. However, in the optical disc type determination method of FIG. 5, an optical disc type is determined according to a determination order based on a frequency that a particular type of optical disc is loaded in the data recording and/or reproducing apparatus. Frequency information and determination order based on the frequency information are stored in the memory 3.

Referring to FIG. 5, when the optical disc 100 is loaded in the data recording and/or reproducing apparatus (operation 510), the control unit 2 reads the information stored in the memory 3 (operation 530). The control unit 2 determines the type of the loaded optical disc 100 according to the determination order read from the memory 3 (operation 550). An example of an optical disc type determination process is substantially similar to that which is illustrated in FIG. 3. After the type of the optical disc 100 is determined in operation 550, the control unit 2 updates the frequency information and the determination order based on the frequency information and stores the updated information in the memory 3 (operation 570).

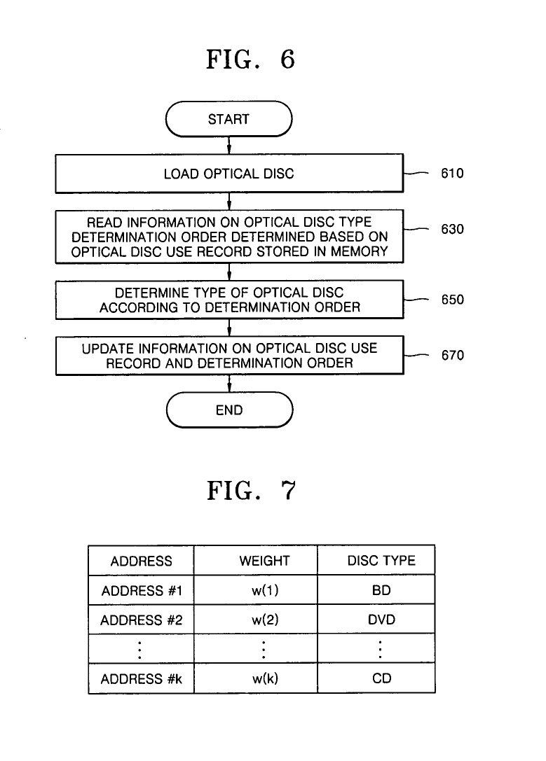

FIG. 6 is a flow chart of an optical disc type determination method according to another embodiment of the present invention. According to this embodiment of the optical disc type determination method, information including an optical disc use record, in which an optical disc recently loaded on the data recording and/or reproducing apparatus is highly weighted, is stored at the memory 3. A type of a presently loaded optical disc is then determined according to a determination order based on the information of the optical disc use record.

Referring to FIG. 6, the optical disc type determination method according to another embodiment of the present invention will now be described. When the optical disc 100 is loaded in the data recording and/or reproducing apparatus (operation 610), the control unit 2 reads the information of the determination order based on the information of the optical disc use record stored in the memory 3 (operation 630).

FIG. 7 is a diagram of an example of the information of the optical disc use record according to the embodiment of the present invention shown in FIG. 6. A disc type that is stored in address #1 of the memory 3 represents the type of the disc that was most recently loaded. In other words, when a number of an address is increased, the increase indicates that the type of disc that was loaded was previously loaded and that another type of disc is presently loaded. Weight 1 through weight k are allotted to the address #1 through #k, respectively, with the value of the weight 1 being the greatest, and the value of the weight k being the smallest. Namely, a recently used disc type has the highest weight. The control unit 2 determines the determination order by referring to the optical disc use record as shown in FIG. 7. All weights corresponding to a BD type are summed. Similarly, after the summed weights corresponding to a DVD and a CD are respectively obtained, the three summed weights are compared to determine the determination order. The determination order is stored at a specific address as shown in FIGS. 4A through 4C.

The control unit 2 determines the type of the loaded optical disc 100 according to the determination order read from the memory 3 (operation 650). An example of an optical disc type determination process is as shown in FIG. 3.

When the type of the optical disc 100 is determined in operation 650, the control unit 2 updates information on an optical disc use record and the determination order based on the information on the optical disc use record and stores the updated determination order at a specific address in the memory 3 (operation 670).

It is understood that while the above discussed embodiments of the invention refer to DVDs, BDs, and CDs, this invention could be applied to other types of discs optical or otherwise.

As is described above, according to the present invention, various methods to change an order for optical disc type determination may be used to rapidly determine what a type of a loaded optical disc is. These include using patterns of optical disc usage, using a frequency of a type of a loaded optical disc, and using a point of time in which an optical disc is used. As such, an initialization time to use an optical disc is reduced.

The invention may also be embodied as computer readable codes on a computer readable recording medium. The computer readable recording medium is any data storage device that stores data which may be thereafter read by a computer system. Examples of the computer readable recording medium include read-only memory (ROM), random-access memory (RAM), CD-ROMs, magnetic tapes, floppy discs, optical data storage devices, and carrier waves (such as data transmission through the Internet). The computer readable recording medium may also be distributed over network coupled computer systems so that the computer readable code is stored and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A data recording and/or reproducing apparatus which reads/writes data from/onto different types of optical discs, comprising:
a read/write unit which reads and/or writes data from/onto an optical disc that is loaded into the apparatus;
a memory which stores an optical disc type determination order to determine what type of optical disc the optical disc is from a plurality of optical disc types; and
a control unit which controls the read/write unit according to the optical disc type determination order stored in the memory to determine the type of the optical disc and updates the determination order based on the determined type of the loaded optical disc.

2. The apparatus of claim 1, wherein the control unit updates the determination order stored in the memory such that the type of the loaded optical disc has top priority.

3. The apparatus of claim 1, wherein the memory is a nonvolatile memory.

4. A method of determining a type of an optical disc that is loaded in a data recording and/or reproducing apparatus, comprising:
reading an optical disc type determination order that is stored in a memory of the data recording and/or reproducing apparatus;
choosing a type of the optical disc from an ordered plurality of optical disc types;
controlling a read/write unit in the data recording and/or reproducing apparatus according to the choosing to determine the type of the optical disc; and
updating the ordered plurality of the optical disc types based on the determined type of the optical disc.

5. The method of claim 4, further comprising updating the ordered plurality of optical disc types stored in the memory such that the type of the presently loaded optical disc has top priority.

6. The method of claim 4, wherein the memory is a nonvolatile memory.

7. A data recording and/or reproducing apparatus which reads/writes data from/onto different types of optical discs, comprising:
a read/write unit which reads/writes data from/onto an optical disc that is loaded into the apparatus;
a memory which stores frequencies of loaded optical disc types and an optical disc type determination order based on the stored frequencies; and
a control unit which controls the read/write unit to determine the type of the loaded optical disc according to the determination order stored in the memory.

8. The apparatus of claim 7, wherein the control unit updates the frequencies and the determination order stored in the memory, after determining the type of the loaded optical disc.

9. The apparatus of claim 7, wherein the memory is a nonvolatile memory.

10. A method of determining the type of an optical disc that is loaded in a data recording and/or reproducing apparatus, comprising:
reading an optical disc type determination order based on frequencies that types of optical discs are loaded into the apparatus, the determination order being stored in a memory included in the data recording and/or reproducing apparatus; and
controlling a read/write unit in the data recording and/or reproducing apparatus according to the determination to determine the type of the loaded optical disc.

11. The method of claim 10, further comprising the operation of updating the frequencies and the determination order stored in the memory, after determining the type of the loaded optical disc.

12. The method of claim 10, wherein the memory is a nonvolatile memory.

13. A data recording and/or reproducing apparatus which reads and/or writes data from/onto different types of optical discs, comprising:
a read/write unit which reads and/or writes data from/onto a loaded optical disc;
a memory which stores information, including an optical discs use record in which an optical disc recently loaded on the data recording and/or reproducing apparatus is highly weighted and an optical disc type determination order based on the information including the optical disc use record; and
a control unit which controls the read/write unit according to the determination order stored in the memory to determine the type of the loaded optical disc.

14. The apparatus of claim 13, wherein the control unit updates information on the optical discs use record and the determination order stored in the memory, after determining the type of the loaded optical disc.

15. The apparatus of claim 13, wherein the memory is a nonvolatile memory.

16. A method of discriminating the type of an optical disc that is loaded in a data recording and/or reproducing apparatus, comprising:
reading an optical disc type determination order stored in a memory included in the data recording and/or reproducing apparatus and determined based on the information on an optical disc use record in which an optical disc recently loaded on the data recording and/or reproducing apparatus is highly weighted; and
controlling a read/write unit of the data recording and/or reproducing apparatus according to the determination to determine the type of a loaded optical disc.

17. The method of claim 16, further comprising the operation of updating the information of the optical disc use record and the determination order stored in the memory, after determining the type of the loaded optical disc.

18. The method of claim 16, wherein the memory is a nonvolatile memory.

19. A computer readable recording medium storing a program to execute a method of determining a type of an optical disc that is loaded in a data recording and/or reproducing apparatus, the method comprising:
reading an optical disc type determination order stored in a memory included in the data recording and/or reproducing apparatus in order to determine a type of the optical disc from a plurality of optical disc types; and
controlling a read/write unit in the data recording and/or reproducing apparatus according to the determination to determine the type of the optical disc.

20. A computer readable recording medium storing a program to execute a method of determining a type of an optical disc that is loaded in a data recording and/or reproducing apparatus, the method comprising:
reading an optical disc type determination order stored in a memory of the data recording and/or reproducing apparatus and determined based on frequencies of optical disc types; and
controlling a read/write unit of the data recording and/or reproducing apparatus according to the determination to determine the type of a loaded optical disc.

21. A computer readable recording medium storing a program to execute a method of determining a type of an optical disc that is loaded in a data recording and/or reproducing apparatus, the method comprising:
reading an optical disc type determination order stored in a memory of the data recording and/or reproducing apparatus and determined based on information on an optical disc use record in which an optical disc recently loaded on the data recording and/or reproducing apparatus is highly weighted; and
controlling a read/write unit of the data recording and/or reproducing apparatus according to the determination to determine a loaded optical disc.

22. A data recording and/or reproducing apparatus to be used with different types of discs, comprising:
a read/write unit to read/write data from/onto a disc that is presently loaded;
a memory to store information describing what types of discs were previously loaded and an determination order based on the information; and
a control unit to determine the type of the presently loaded disc according to the stored determination order and to update the information based on the determined type of the presently loaded disc.

23. The apparatus according to claim 22, wherein optical discs are to be loaded into the apparatus.

24. The apparatus according to claim 22, wherein the information comprises:
a description of types of discs that were previously loaded;
frequencies that certain types of discs are loaded; and
a record of disc type usage.

25. The apparatus according to claim 24, wherein the record is written based on the frequencies that certain types of discs are loaded and weights assigned to certain frequencies.

26. The apparatus according to claim 22, wherein the read/write unit comprises a spindle motor to rotate the disc and a pickup, including a laser diode and a lens.

27. A method of determining a type of a disc that is presently loaded in a data recording and/or reproducing apparatus having a determination order stored therein, the method comprising:
reading a high priority disc type from the determination order;
testing to determine whether the type of the presently loaded disc matches the read high priority disc type; and
reading a next high priority disc type from the determination order and retesting to determine whether the type of the presently loaded disc matches the read next high priority disc type, if the presently loaded disc does not match the read high priority disc type; and
updating the disc type determination order with information relating to the type of the presently loaded disc.

28. The method according to claim 27, further comprising assigning priority to various disc types based on information relating to disc types of previously loaded discs.

29. The method according to claim 28, further comprising:
describing types of discs that were previously loaded;
determining frequencies that certain types of discs are loaded; and
writing a record of disc type usage, wherein the information relating to disc types of previously loaded discs comprises the description of the types of discs that were previously loaded, the determined frequencies, and the written record.

30. The method according to claim 29, wherein the writing of the record comprises:
determining frequencies that certain types of discs are loaded;
assigning weights to certain frequencies; and
wiring the record based on the assigned weights.

31. The method according to claim 27, wherein when the read high priority disc type is that of a digital versatile disc (DVD), the method further comprises performing a specific disc detection (DDT) process related to DVDs.

32. The method according to claim 32, further comprising determining whether the DVD is a rewritable DVD or a read only DVD.

33. The method according to claim 27, wherein if the read high priority disc type is that of a BLU-RAY (BD) disc, the method further comprises performing a specific disc detection (DT) process related to BDs.

34. The method according to claim 27, wherein the updating comprises assigning the type of the presently loaded disc the high priority.

35. The method according to claim 35, wherein the updating comprises assigning the type of an immediately previously loaded disc the next high priority.

36. A computer readable medium to execute the method of claim 27.
